(19) United States
(12) Patent Application Publication
(10) Pub. No.: US 2025/0131589 A1
(43) Pub. Date: Apr. 24, 2025

(54) HEAD POSE ESTIMATION METHOD AND APPARATUS, DEVICE, AND STORAGE MEDIUM

(71) Applicant: Tencent Technology (Shenzhen) Company Limited, Shenzhen (CN)

(72) Inventor: Huawei WEI, Shenzhen (CN)

(73) Assignee: Tencent Technology (Shenzhen) Company Limited, Shenzhen (CN)

(21) Appl. No.: 19/002,558

(22) Filed: Dec. 26, 2024

Related U.S. Application Data
(63) Continuation of application No. PCT/CN2023/108312, filed on Jul. 20, 2023.

(30) Foreign Application Priority Data
Sep. 15, 2022 (CN) 202211130441.4

(51) Int. Cl. G06T 7/73; G06V 10/20; G06V 10/77; G06V 10/774; G06V 10/82; G06V 40/16

(52) U.S. Cl. CPC G06T 7/73; G06V 10/20; G06V 10/7715; G06V 10/774; G06V 10/82; G06V 40/165; G06V 40/171; G06T 2207/10028; G06T 2207/30201

(57) ABSTRACT

In a head pose estimation method, the method includes obtaining an image. The image includes a target face. Key point recognition processing is performed through a first network model based on the image. A two-dimensional key point coordinate set and a three-dimensional key point coordinate set of the target face are obtained. The first network model includes a first branch network that is configured to recognize the two-dimensional key point coordinate set and a second branch network that is configured to recognize the three-dimensional key point coordinate set. A head pose corresponding to the target face in the image is determined according to the two-dimensional key point coordinate set and the three-dimensional key point coordinate set.

### RELATED APPLICATIONS

The present application is a continuation of International Application No. PCT/CN2023/108312, filed on Jul. 20, 2023, which claims priority to Chinese Patent Application No. 202211130441.4, filed on Sep. 15, 2022. The entire disclosures of the prior applications are hereby incorporated by reference.

### FIELD OF THE TECHNOLOGY

This disclosure relates to the field of image processing, including to head pose estimation technologies.

### BACKGROUND OF THE DISCLOSURE

In the context of computer vision, head pose estimation refers to the ability to infer the orientation of a person's head relative to the camera view. In visual dynamic capture scenarios, head pose estimation is a very important part. An accurate head pose allows a virtual character to perfectly replicate a head motion of a person, making a virtual animation more vivid, dexterous, and realistic.

Currently, a mainstream head pose estimation method generally requires the use of a traditional motion sensor or a three-dimensional (3D) image acquisition device to obtain three-dimensional coordinate information of the head. However, since the current mainstream image acquisition device collects two-dimensional (2D) image information, it is necessary to implement 3D conversion of the 2D coordinate information in the world coordinate system based on coordinate information of key points of the face, to obtain 3D coordinate information of a head pose of a person, and then estimation of the head pose and judgment of the head motion are implemented based on changes in the coordinate information.

The above method is based on the method of solving motion from 3D to 2D point pairs (also called perspective-n-point (PnP)). In this method, 2D key points of the face are first estimated, and then corresponding 3D points are calibrated in a fixed 3D head model based on the 2D key points. Through PnP solution, a transformation pose of the 3D points corresponding to the 2D key points may be obtained. Although the above method is generally accurate and interpretable, when a person makes a large expression, the jitter is very significant, and the estimated head pose is not sufficiently stable and reliable.

### SUMMARY

This disclosure provides a head pose estimation method and apparatus, a device, and a non-transitory computer readable storage medium, which can improve the stability and reliability of head pose estimation.

In view of the above, according to an aspect of this disclosure, a head pose estimation method is provided, the method includes obtaining an image. The image includes a target face. Key point recognition processing is performed through a first network model based on the image. A two-dimensional key point coordinate set and a three-dimensional key point coordinate set of the target face are obtained. The first network model includes a first branch network that is configured to recognize the two-dimensional key point coordinate set and a second branch network that is configured to recognize the three-dimensional key point coordinate set. A head pose corresponding to the target face in the image is determined according to the two-dimensional key point coordinate set and the three-dimensional key point coordinate set.

According to an aspect of this disclosure, a head pose estimation apparatus is provided, including processing circuitry is provided. The processing circuitry is configured to obtain an image, that includes a target face. The processing circuitry is configured to perform key point recognition processing through a first network model based on the image. A two-dimensional key point coordinate set and a three-dimensional key point coordinate set of the target face are obtained. The first network model includes a first branch network that is configured to recognize the two-dimensional key point coordinate set and a second branch network that is configured to recognize the three-dimensional key point coordinate set. The processing circuitry is configured to determine, according to the two-dimensional key point coordinate set and the three-dimensional key point coordinate set, a head pose corresponding to the target face in the image.

According to an aspect of this disclosure, a computer device is provided, including: a memory, a processor, and a bus system,
the memory being configured to store a program;
the processor being configured to execute the program in the memory, and the processor being configured to execute the method according to the foregoing aspect based on instructions in program code; and
the bus system being configured to connect the memory and the processor, causing the memory to communicate with the processor.

According to an aspect of this disclosure, a non-transitory computer-readable storage medium is provided, the non-transitory computer-readable storage medium stores instructions, and when executed by a processor cause the processor to perform the method according to the foregoing aspect.

According to an aspect of this disclosure, a computer program product or a computer program is provided, including computer instructions stored in a computer-readable storage medium. A processor of a computer device reads the computer instructions from the computer-readable storage medium, and the processor executes the computer instructions, so that the computer device executes the method according to the foregoing aspect.

According to the foregoing technical solutions, it can be learned that the embodiments of this disclosure have the following advantages: The two branch networks are used to respectively output the 2D key point coordinates and the 3D key point coordinates of the target face image in the to-be-recognized image, and then calculate the head pose of the target face image based on the 2D key point coordinates and the 3D key point coordinates. Since the 3D key point coordinate may be obtained in real time, a 3D head model may change with changes in expressions. Correspondingly, the correspondence between the 2D key point coordinate and the 3D key point coordinate is more accurate, so that when a person makes a large expression, it is ensured that head pose solution is stable and reliable.

### BRIEF DESCRIPTION OF THE DRAWINGS

FIG. 1 is a schematic architectural diagram of an application system according to an embodiment of this disclosure;

FIG. 2 is a schematic architectural diagram of a first network model according to an embodiment of this disclosure;

FIG. 3 is another schematic architectural diagram of a first network model according to an embodiment of this disclosure;

FIG. 4 is a schematic flowchart of a head pose estimation method according to an embodiment of this disclosure;

FIG. 5 is a schematic diagram of a target face image in a to-be-recognized image according to an embodiment of this disclosure;

FIG. 6 is a schematic flowchart of processing a to-be-processed image through an image processing model to obtain a to-be-recognized image according to an embodiment of this disclosure;

FIG. 7a is a schematic diagram of an embodiment of head pose estimation according to an embodiment of this disclosure;

FIG. 7b is a schematic diagram of a virtual character generated after performing head pose estimation on a to-be-processed image according to an embodiment of this disclosure;

FIG. 8 is a schematic diagram of an embodiment of a head pose estimation apparatus according to an embodiment of this disclosure;

FIG. 9 is a schematic diagram of another embodiment of a head pose estimation apparatus according to an embodiment of this disclosure;

FIG. 10 is a schematic diagram of another embodiment of a head pose estimation apparatus according to an embodiment of this disclosure; and

FIG. 11 is a schematic diagram of another embodiment of a head pose estimation apparatus according to an embodiment of this disclosure.

### DETAILED DESCRIPTION

The terms such as “first”, “second”, “third”, and “fourth” (if any) in the specification and claims of this disclosure and in the accompanying drawings are used for distinguishing similar objects and not necessarily used for describing any particular order or sequence. Data used in this way is exchangeable in a proper case, so that the embodiments of this disclosure described herein may be implemented in an order different from the order shown or described herein. In addition, the terms “include”, “corresponding to” and any other variants are intended to cover the non-exclusive inclusion. For example, a process, method, system, product, or device that includes a series of operations or units is not necessarily limited to those expressly listed operations or units, but may include other operations or units not expressly listed or inherent to such a process, method, product, or device. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A to-be-recognized image is obtained, the to-be-recognized image including a target face image; the to-be-recognized image is inputted into a first network model, to obtain a two-dimensional key point coordinate set of the target face image in the to-be-recognized image and a three-dimensional key point coordinate set of the target face image, the first network model including a first branch network and a second branch network, the first branch network being configured for recognizing the two-dimensional key point coordinate set, and the second branch network being configured for recognizing the three-dimensional key point coordinate set; and it is determined, according to the two-dimensional key point coordinate set and the three-dimensional key point coordinate set, a head pose corresponding to the target face image in the to-be-recognized image. In the embodiments of this disclosure, since the 3D key point coordinates of the face image in the to-be-recognized image may be obtained in real time, it is ensured that a 3D head model may change with changes in expressions of a person. Correspondingly, the correspondence between the 2D key point coordinate and the 3D key point coordinate is more accurate, so that when a person makes a large expression in the to-be-recognized image, it is ensured that head pose solution is stable and reliable.

To facilitate understanding, the following explains some terminologies involved in this disclosure.

Key points of facial features: used to represent positions of the facial features on a face. The positions of the facial features may be represented by key points. The key points of facial features involved in the embodiments of this disclosure include points corresponding to five positions of the left pupil, the right pupil, the nose tip, the left mouth corner, and the right mouth corner of a face.

Eulerian angles: a set of 3 independent angular parameters proposed by Euler to determine the position of a fixed-point rotating rigid body. In the embodiments of this disclosure, a rectangular coordinate system is established based on the face. In the embodiments of this disclosure, a face pose angle is, for example, the Eulerian angle. The Eulerian angle is in a three-dimensional rectangular coordinate system. The three-dimensional rectangular coordinate system uses the center or center of gravity of the person's head as the origin, a direction from one ear of the face to the other ear is the X axis, a direction from the top of the head of the person to the neck is the Y axis, and a direction from the face of the person to the rear head is the Z axis. The Eulerian angle includes the following three angles:
pitch angle (pitch): angle rotating around the X axis;
yaw angle (yaw): angle rotating around the Y axis; and
roll angle (roll): angle rotating around the Z axis.

Visual motion capture: Traditional motion capture uses inertial sensors or marker points attached to the human body for motion capture. Visual motion capture does not require a person to wear any device and may capture facial and body motions of a person using single or multiple cameras.

6 degrees of freedom (6DoF): DoF is the number of directions in which an object may move in a 3D space, and there are a total of 6 degrees of freedom. That is, a head pose includes rotation and translation. The rotation is represented by 3 Eulerian angles, and the translation is also represented by displacements in 3 directions. In total, there are 6 degrees of freedom pose parameters.

Perspective-n-point (PnP): PnP is a method for solving the motion from 3D to 2D point pairs. The purpose is to solve the pose of the camera coordinate system relative to the world coordinate system. PnP describes how to estimate the pose of a camera (that is, solve a rotation matrix and a translation vector from the world coordinate system to the camera coordinate system) based on known coordinates of several 3D points (relative to the world coordinate system) and 2D coordinates of these points.

A convolutional layer (Conv) refers to a layered structure including several convolution units in a convolutional neural network layer, and a convolutional neural network (CNN) is a feedforward neural network. The convolutional neural network includes at least two neural network layers. Each neural network layer includes several neurons, the neurons are arranged hierarchically, there are no interconnections between neurons in the same layer, and the transmission of information between layers only occurs in one direction.

A pooling layer, also known as a sampling layer, refers to a layered structure that may extract features from an input value twice. The pooling layer may ensure the main features of the value of the previous layer, and may also reduce the parameters and calculation amount of the next layer. The pooling layer includes multiple feature surfaces. One feature surface of the convolutional layer corresponds to a feature surface in the pooling layer. The number of feature surfaces is not changed. By reducing the resolution of the feature surfaces, a spatially invariance feature may be obtained.

A fully connected layer (FC) means that each node in the layered structure is connected to all nodes in the previous layer and may be configured to perform comprehensive processing on features extracted by the previous neural network layer and plays the role of a “classifier” in the neural network model.

Back propagation: Forward propagation refers to the feedforward processing process of the model. Back propagation is the opposite of forward propagation and refers to updating the weight parameters of each layer of the model based on results output by the model. For example, the model includes an input layer, a hidden layer, and an output layer. In this case, forward propagation refers to processing in the order of input layer-hidden layer-output layer, and back propagation refers to updating weight parameters of each layer in the order of output layer-hidden layer-input layer.

Embodiments of this disclosure provide a head pose estimation method and apparatus, a device, and a storage medium, which can ensure the stability and reliability of head pose estimation. The electronic device provided by the embodiments of this disclosure may be implemented as various types of user terminals or as servers.

By running the head pose estimation solution provided by the embodiments of this disclosure, the electronic device can ensure the stability and reliability of the head pose estimation, that is, the stability and reliability of the head pose estimation of the electronic device are improved, and this is suitable for multiple application scenarios of head pose estimation, for example, augmented reality (AR) games, virtual reality (VR) games, assisting gaze estimation, modeling attention, making 3D models suitable for videos, and performing facial alignment.

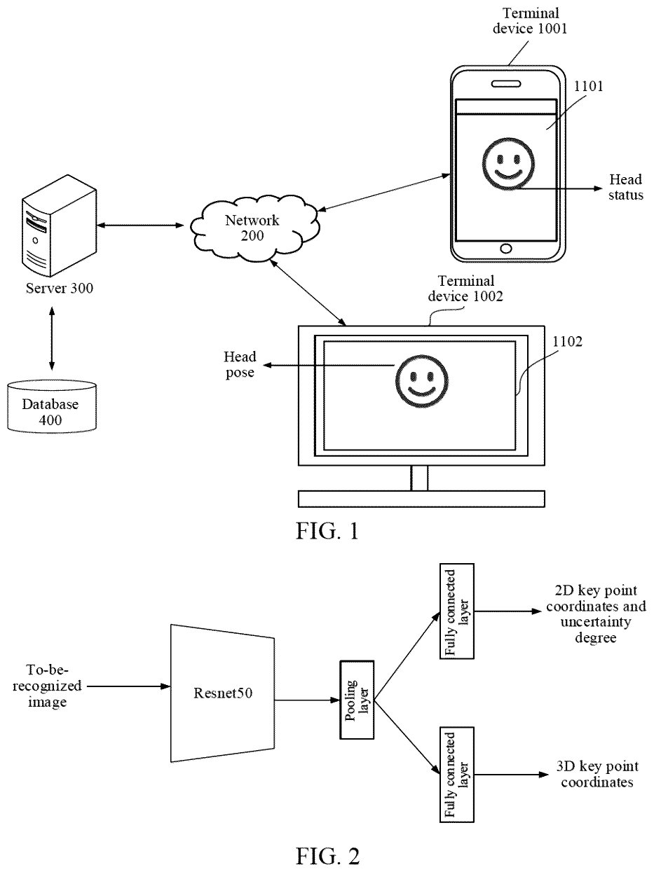

FIG. 1 is a schematic architectural diagram of an application scenario of a head pose estimation solution according to an embodiment of this disclosure. To support a head pose estimation application, a terminal device 100 (a terminal device 1001 and a terminal device 1002 are exemplarily shown) is connected to a server 300 through a network 200, the server 300 is connected to a database 400, and the network 200 may be a wide area network or a local area network, or a combination thereof.

A client used to implement the head pose estimation solution is deployed on the terminal device 100. The client may run on the terminal device 100 in the form of a browser and may also run on the terminal device 100 in the form of an independent application (APP). The specific presentation form of the client is not limited herein.

The server 300 involved in this application may be an independent physical server, a server cluster including multiple physical servers, or a distributed system, or a cloud server that may provide basic cloud computing services such as cloud services, cloud databases, cloud computing, cloud functions, cloud storage, network services, cloud communications, middleware services, domain name services, security services, and content delivery networks (CDN), big data, and artificial intelligence platforms. The terminal device 100 may be a smartphone, a tablet computer, a laptop computer, a handheld computer, a personal computer, a smart TV, a smartwatch, an in-vehicle device, a wearable device, or the like, but is not limited to this. The terminal device 100 and the server 300 may be connected by the network 200 directly or indirectly through wired or wireless communication, which is not limited in this disclosure. There is no limitation on the number of servers 300 and terminal devices 100. The solution provided by this disclosure may be completed independently by the terminal device 100, or independently by the server 300, or by the terminal device 100 and the server 300 in cooperation. This disclosure does not specifically limit this.

The database 400 may be regarded as an electronic file cabinet, that is, a place in which electronic files are stored. Users may add, query, update, or delete data in the files or perform other operations. A database is a data set that is stored in a specific manner, may be shared with multiple users, has as little redundancy as possible, and is independent of applications. A database management system (DBMS) is a computer software system designed for managing databases and generally has basic functions such as storage, interception, security guarantee, and backup. Database management systems may be classified according to database models supported by the systems, such as relational and extensible markup language (XML); or classified according to types of computers supported by the systems, such as server clusters and mobile phones; or classified according to query languages used, such as structured query language (SQL) and XQuery; or classified according to the focus of performance impulse, such as maximum scale and maximum operating speed; or classified in other methods. Regardless of which classification method is used, some DBMS are capable of spanning categories, for example, support multiple query languages simultaneously. The database 400 may be configured to store a training sample set and a to-be-recognized image. Certainly, the storage location of the training sample set is not limited to the database. For example, the set may also be stored in the terminal device 100, a blockchain, or a distributed file system of the server 300.

In some embodiments, the server 300 may execute the head pose estimation method provided in the embodiments of this disclosure and the training method of the first network model in head pose estimation. In this embodiment, the first network model includes a first branch network and a second branch network, where the first branch network is configured for recognizing two-dimensional key point coordinates and the uncertainty factor, and the second branch network is configured for recognizing three-dimensional key point coordinates. When executing the training method of the first network model, the specific process may be as follows: a first training sample set correspondingly labeled with real 2D key point coordinates and real 3D key point coordinates is obtained from the terminal device 100 and/or the database 400, and the first training sample set is detected and processed through a to-be-trained first initial network model, to obtain predicted 2D key point coordinates and predicted 3D key point coordinates of each face in the first training sample set. In an embodiment, an uncertainty factor corresponding to the predicted 2D key point coordinates may be further obtained. According to a loss function including pre-design loss factors (such as two factors: interval value and distance), a first loss value corresponding to the predicted 2D key point coordinates and the uncertainty factor corresponding to the predicted 2D key point coordinates is determined, and a second loss value corresponding to the predicted 3D key point coordinates is determined, and then back propagation is performed to adjust the parameters of the first branch network according to the first loss value. At the same time, back propagation is performed to adjust parameters of the second branch network according to the second loss value, thereby achieving training of the first initial network model and obtaining the first network model. In this embodiment, the first branch network and the second branch network are trained independently and do not affect parameter adjustment of each other. This can improve the generalization capabilities of the first branch network and the second branch network. In this embodiment, when training the first network model, the server may calculate the first loss value using Gaussian negative log-likelihood loss (GNLL). In an example, the specific calculation process may adopt the formula 1:

$$loss = - \frac{1}{N} \sum log ( {δ}^{2} ) + \frac{‖ f ( x ) - y ‖}{{δ}^{2}} \qquad formula 1$$

N is used to indicate the number of 2D key points, y is used to indicate the real 2D key point coordinates, f(x) is used to indicate the predicted 2D key point coordinates output by the first branch network, and δ is used to indicate the uncertainty factor of the predicted 2D key point coordinates.

The server may calculate the second loss value using the regression loss function. In an example, the server uses L2 LOSS, and the specific calculation process may adopt the formula 2:

$$loss = - \frac{1}{N} \sum ‖ f ( x ) - y ‖ \qquad formula 2$$

N is used to indicate the number of 3D key points, y is used to indicate the real 3D key point coordinates, and f(x) is used to indicate the predicted 3D key point coordinates output by the second branch network.

When the server 300 trains the first network model, the initial model architecture of the first network model may include a feature extraction network, a fully connected layer, a pooling layer, the first branch network, and the second branch network. The feature extraction network may be a residual neural network (ResNet) or a CNN network such as Le Net or AlexNet, or a high-resolution netV2P (HRNetV2P), or a hierarchical visual self attention model based on moving windows (Swin Transformer), and the first branch network and the second branch network may be fully connected layers. In an example, the following takes the feature extraction network as ResNet50 as an example to illustrate the first network model. As shown in FIG. 2, the first network model includes the ResNet50, where the ResNet50 includes 49 convolutional layers and one fully connected layer, and the fully connected layer is then connected to the pooling layer. The output of the pooling layer is connected to two fully connected layers, one fully connected layer is the first branch network, and the other fully connected layer is the second branch network. The input of the network is 224×224×3. After the convolution calculation of the above structure, the output is 7×7×2048. The pooling layer converts the output into an Eigenvector, and finally the classifier calculates this Eigenvector and outputs a class probability. The ResNet50 network structure may be divided into seven parts. The first part does not include a residual block and mainly performs convolution, regularization, activation function, and maximum pooling calculations on the input. The second, third, fourth, and fifth parts of the structure all include residual blocks. The existence does not change the size of the residual block, but is only used to change the structure of the dimension of the residual block. In the Resnet50 network structure, each residual block has three convolutional layers, and the network has a total of 1+3×(3+4+6+3)=49 convolutional layers. By adding the final fully connected layer, the total is 50 layers, hence the name Resnet50. The input of the Resnet50 network is 256×256×3. After the convolution calculation of the first five parts, the output is a feature map of N×2048×8×8, where N is the number of samples selected for a training (also called batchsize). Then, the feature map of N×2048×8×8 passes through the pooling layer to obtain the feature of N×2048. The feature of N×2048 passes through two FC layers, and 2D key point coordinates, the uncertainty factor, and 3D key point coordinates are outputted respectively. The weight dimension of each FC layer is 2048×3660 (1220 points), where 3660 is considered as 1220×3. For the 2D branch, 3 represents the x and y coordinates and the uncertainty factor δ. For the 3D branch, 3 represents the x, y, and z coordinate values.

In some other embodiments, the server 300 may execute the head pose estimation method provided in the embodiments of this disclosure and the training method of the first network model in head pose estimation. In this embodiment, the first network model includes a first branch network, a second branch network, and a computing network, where the first branch network is configured to recognize two-dimensional key point coordinates, and the second branch network is configured to recognize three-dimensional key point coordinates. The computing network is configured to estimate the head pose based on the 2D key point coordinates and the 3D key point coordinates. When executing the training method of the first network model, the specific process may be as follows: a second training sample set correspondingly labeled with real 2D key point coordinates, real 3D key point coordinates, and a real head pose is obtained from the terminal device 100 and/or the database 400, and the second training sample is detected and processed through a to-be-trained second initial network model, to obtain predicted 2D key point coordinates and predicted 3D key point coordinates of each face in the second training sample set. In an embodiment, an uncertainty factor corresponding to the predicted 2D key point coordinates may be further obtained. According to a loss function including pre-design loss factors (such as two factors: interval value and distance), a first loss value corresponding to the predicted 2D key point coordinates and the uncertainty factor corresponding to the predicted 2D key point coordinates is determined, and a second loss value corresponding to the predicted 3D key point coordinates is determined. Then, a predicted head pose is calculated according to the predicted 2D key point coordinates and the predicted 3D key point coordinates, and the third loss value is calculated according to the predicted head pose and the real head pose. Then, according to the first loss value, the second loss value, and the third loss value, back propagation is performed to adjust the parameters of the first branch network and the second branch network, thereby achieving training of the second initial network model and obtaining the first network model. In this embodiment, the first branch network and the second branch network may be jointly trained, so that the two branches may affect each other and enhance the network learning capability. In this embodiment, when training the first network model, the server may calculate the first loss value using Gaussian negative log-likelihood loss (GNLL). In an example, the specific calculation process may adopt the formula 1:

$$loss = - \frac{1}{N} \sum log ( {δ}^{2} ) + \frac{‖ f ( x ) - y ‖}{{δ}^{2}} \qquad formula 1$$

N is used to indicate the number of 2D key points, y is used to indicate the real 2D key point coordinates, f(x) is used to indicate the predicted 2D key point coordinates output by the first branch network, and δ is used to indicate the uncertainty factor of the predicted 2D key point coordinates.

The server may calculate the second loss value using the regression loss function. In an example, the server uses L2 LOSS, and the specific calculation process may adopt the formula 2:

$$loss = - \frac{1}{N} \sum ‖ f ( x ) - y ‖ \qquad formula 2$$

N is used to indicate the number of 3D key points, y is used to indicate the real 3D key point coordinates, and f(x) is used to indicate the predicted 3D key point coordinates output by the second branch network.

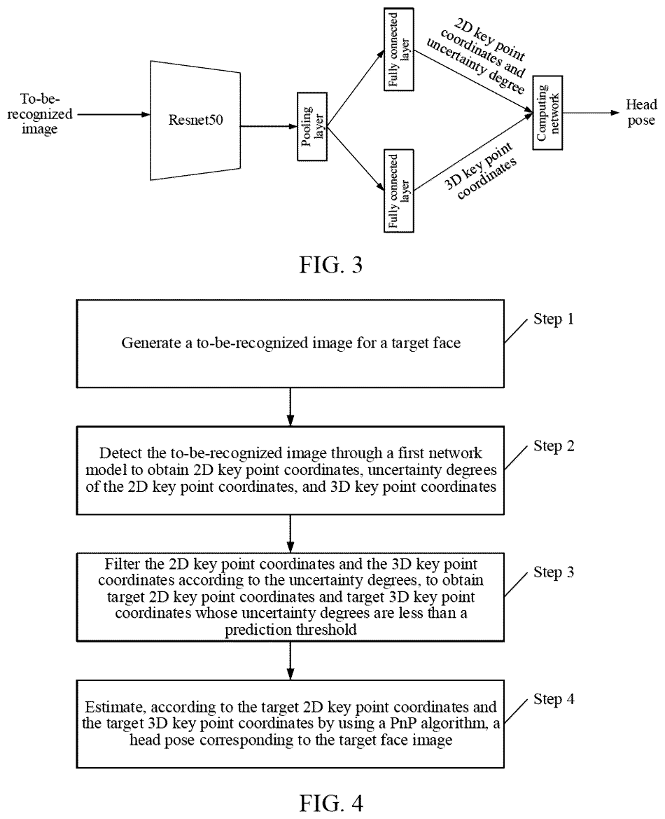

When the server 300 trains the first network model, the initial model architecture of the first network model may include a feature extraction network, a fully connected layer, a pooling layer, the first branch network, the second branch network, and the computing network. The feature extraction network may be a residual neural network (ResNet) or a CNN network such as Le Net or AlexNet, or a high-resolution netV2P (HRNetV2P), or a hierarchical visual self attention model based on moving windows (Swin Transformer), and the first branch network and the second branch network may be fully connected layers. In an example, the following takes the feature extraction network as ResNet50 as an example to illustrate the first network model. As shown in FIG. 3, the first network model includes the ResNet50, where the ResNet50 includes 49 convolutional layers and one fully connected layer, and the fully connected layer is then connected to the pooling layer. The output of the pooling layer is connected to two fully connected layers, one fully connected layer is the first branch network, and the other fully connected layer is the second branch network. The input of the network is 224×224×3. After the convolution calculation of the above structure, the output is 7×7×2048. The pooling layer converts the output into an Eigenvector, and finally the classifier calculates this Eigenvector and outputs a class probability. The ResNet50 network structure may be divided into five parts. The first part does not include a residual block and mainly performs convolution, regularization, activation function, and maximum pooling calculations on the input. The second, third, fourth, and fifth parts of the structure all include residual blocks. The existence does not change the size of the residual block, but is only used to change the structure of the dimension of the residual block. In the Resnet50 network structure, each residual block has three convolutional layers, and the network has a total of 1+3×(3+4+6+3)=49 convolutional layers. By adding the final fully connected layer, the total is 50 layers, hence the name Resnet50. The input of the Resnet50 network is 256×256×3. After the convolution calculation of the first five parts, the output is a feature map of N×2048×8×8, where N is the number of samples selected for a training (also called batchsize). Then, the feature map of N×2048×8×8 passes through the pooling layer to obtain the feature of N×2048. The feature of N×2048 passes through two FC layers, and 2D key point coordinates, the uncertainty factor, and 3D key point coordinates are outputted respectively. The weight dimension of each FC layer is 2048×3660 (1220 points), where 3660 is considered as 1220×3. For the 2D branch, 3 represents the x and y coordinates and the uncertainty factor δ. For the 3D branch, 3 represents the x, y, and z coordinate values. Then, the predicted head pose is calculated according to the predicted 2D key point coordinates and the uncertainty factor outputted by the first branch network and the predicted 3D key point coordinates outputted by the second branch network.

In this embodiment, the following technical solution may be used for the data of the first training sample set and the second training sample set: That is, the face image is collected through the depth camera of the terminal device, and then face 3D point cloud data and a corresponding head pose are captured in real time by using an augmented reality technology (ARKit) based on a device system, data collection software is developed based on ARKit, and then facial data is collected at a speed of 60 frames (FPS). In this way, facial data collection based on an existing technology may reduce the difficulty of collecting training sample sets.

Other external cameras may also be used when obtaining the first training sample set and the second training sample set. The external camera may be a depth camera or other cameras, as long as facial data collection may be achieved, and the specific method is not limited herein. In this way, using external devices for facial data collection may reduce the requirements for hardware devices, thereby reducing costs.

After training the first network model, the server 300 may save the first network model locally, thereby providing a remote head pose estimation function for the terminal device 100. For example, the server 300 may receive the to-be-recognized image sent by the terminal device 100, and detect and process the to-be-recognized image through the first network model, to obtain a head pose corresponding to the target face image in the to-be-recognized image and a corresponding confidence probability. Finally, the head pose is sent to the terminal device 100, so that the terminal device 100 displays the head pose in a graphical interface 110 (for example, a graphical interface 1101 and a graphical interface 1102).

The server 300 may also send (deploy) the trained first network model to the terminal device 100, thereby implementing head pose estimation locally on the terminal device 100. For example, the terminal device 100 may obtain the to-be-recognized image in real time or obtain the to-be-recognized image from other devices, and detect and process the to-be-recognized image through the first network model, to obtain a head pose corresponding to the target face image in the to-be-recognized image and a corresponding confidence probability. Finally, the terminal device 100 displays the head pose in a graphical interface 110 (for example, a graphical interface 1101 and a graphical interface 1102).

Based on the above system, referring to FIG. 4 for details, an execution process of the head pose estimation method in this disclosure may be as follows:

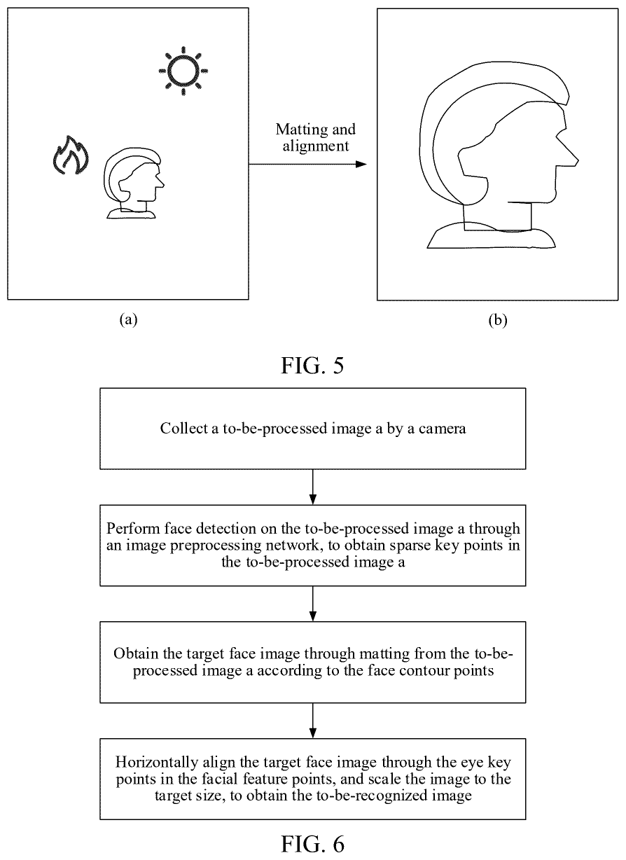

Operation 1: Generate a to-be-recognized image for a target face. In this embodiment, the to-be-recognized image includes a target face image, where the target face image refers to an area in the to-be-recognized image that only includes a face image and does not include other background images. As shown in FIG. 5, (a) in FIG. 5 is an image including a background image, while (b) in FIG. 5 is the to-be-recognized image including the target face image. In this embodiment, various cameras may first collect a to-be-processed image including other background images, and then preprocess the to-be-processed image to obtain the to-be-recognized image. A specific process may be shown in FIG. 6: A to-be-processed image a is collected by a camera. Then, sparse key points in the to-be-processed image a are obtained through face detection, where the sparse key points may be facial feature points and face contour points. Then, the target face image is obtained through matting from the to-be-processed image according to the face contour points. Then, the target face image is horizontally aligned through the eye key points in the facial feature points, and the image is scaled to the target size, thereby obtaining the to-be-recognized image.

Operation 2: Detect the to-be-recognized image through a first network model to obtain 2D key point coordinates, uncertainty factors of the 2D key point coordinates, and 3D key point coordinates.

Operation 3: Filter the 2D key point coordinates and the 3D key point coordinates according to the uncertainty factors, to obtain target 2D key point coordinates and target 3D key point coordinates whose uncertainty factors are less than a prediction threshold.

Operation 4: Estimate, according to the target 2D key point coordinates and the target 3D key point coordinates by using a PnP algorithm. a head pose corresponding to the target face image.

For example, related data such as the to-be-detected image and the training sample set is involved, when the embodiments of this disclosure are applied to a specific product or technology, it is necessary to obtain the user's permission or consent, and the collection, usage, and processing of related data need to comply with relevant laws, regulations and standards of relevant countries and regions.

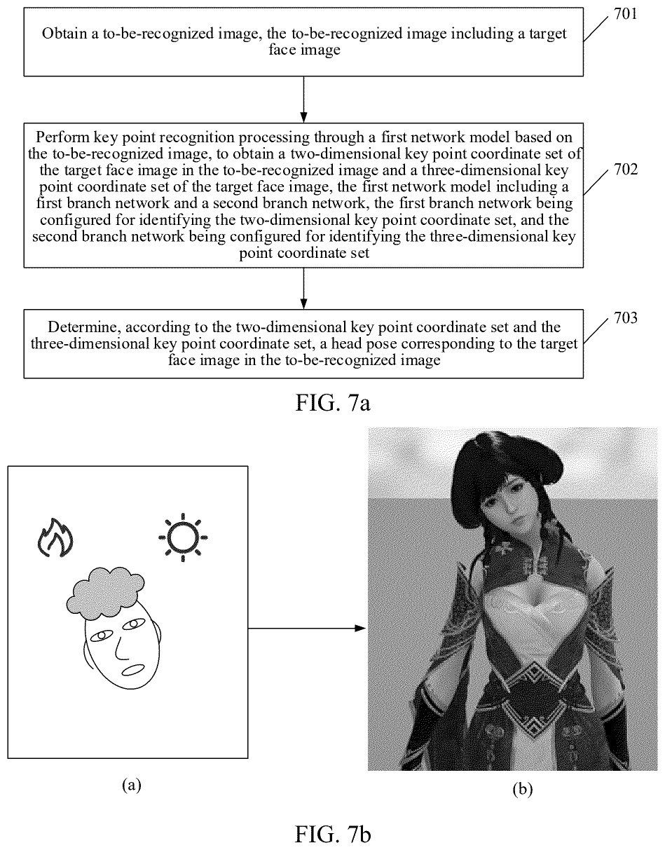

Based on the above introduction, the following takes the terminal device as the execution subject as an example to introduce the head pose estimation method in this disclosure. Referring to FIG. 7a, an embodiment of the head pose estimation method in the embodiment of this disclosure includes:

701: Obtain a to-be-recognized image, the to-be-recognized image including a target face image.

The terminal device may collect the to-be-processed image through its own camera, and then input the to-be-processed image into the image processing model for processing, to obtain the to-be-recognized image. Alternatively, the terminal device may also obtain the to-be-recognized image stored in the memory. Alternatively, the terminal device may also obtain the to-be-recognized image through an instant messaging application, and the instant messaging application refers to software that enables online chatting and communication through an instant messaging technology. Alternatively, the terminal device may also obtain the to-be-recognized image from the Internet, for example, obtain video images from a video network on the Internet and extract a face image from the video images, or for another example, directly download the face image from the Internet, or the like.

In an example, the specific process may be as follows: obtaining a to-be-processed image, where the to-be-processed image includes a target face image captured by a camera; then determining sparse key points of the target face image in the to-be-processed image through an image preprocessing network, where the sparse key points include facial feature points and face contour points of the target face image; obtaining the target face image from the to-be-processed image according to the face contour points; and horizontally aligning the target face image and scaling the target face image to a target size according to the facial feature points to obtain the to-be-recognized image.

The target face image refers to an area in the to-be-recognized image that only includes a face image and does not include other background images. As shown in FIG. 5, (a) in FIG. 5 is an image including a background image, while (b) in FIG. 5 is the to-be-recognized image including the target face image. In this embodiment, various cameras may first collect a to-be-processed image including background images, and then preprocess the to-be-processed image to obtain the to-be-recognized image.

A specific process may be shown in FIG. 6: A to-be-processed image a is collected by a camera. Then, face detection is performed on the to-be-processed image a through an image preprocessing network, to obtain sparse key points in the to-be-processed image a, where the sparse key points may be facial feature points and face contour points. Then, the target face image is obtained through matting from the to-be-processed image a according to the face contour points. Then, the target face image is horizontally aligned through the eye key points in the facial feature points, and the horizontally aligned target face image is scaled to the preset target size, thereby obtaining the to-be-recognized image.

702: Perform key point recognition processing through a first network model based on the to-be-recognized image, to obtain a two-dimensional key point coordinate set of the target face image in the to-be-recognized image and a three-dimensional key point coordinate set of the target face image, the first network model including a first branch network and a second branch network, the first branch network being configured for recognizing the two-dimensional key point coordinate set, and the second branch network being configured for recognizing the three-dimensional key point coordinate set.

In addition, key point processing is performed through the first network model based on the to-be-recognized image, and the uncertainty factor corresponding to each two-dimensional key point in the two-dimensional key point coordinate set may also be obtained. The uncertainty factor is recognized by the first branch network in the first network model.

The terminal device inputs the to-be-recognized image into the first network model, and then the feature extraction network of the first network model performs corresponding feature extraction on the to-be-recognized image, to obtain the final feature representation of the to-be-recognized image. The final feature representation is then inputted into the first branch network and the second branch network of the first network model respectively. The first branch network outputs the two-dimensional key point coordinate (that is, 2D key point coordinates) set of the target face image in the to-be-recognized image and the uncertainty factor. The second branch network outputs the three-dimensional key point coordinate (that is, 3D key point coordinates) set of the target face image in the to-be-recognized image.

The training process of the first network model may be shown in FIG. 2 to FIG. 3, and the details will not be repeated herein.

703: Determine, according to the two-dimensional key point coordinate set and the three-dimensional key point coordinate set, a head pose corresponding to the target face image in the to-be-recognized image.

When the first network model also outputs the uncertainty factor corresponding to each two-dimensional key point coordinate in the two-dimensional key point coordinate set, the terminal device may determine, according to the two-dimensional key point coordinate set, the uncertainty factor corresponding to each two-dimensional key point coordinate in the two-dimensional key point coordinate set, and the three-dimensional key point coordinate set, the head pose corresponding to the target face image in the to-be-recognized image.

In this embodiment, the terminal device may filter the two-dimensional key point coordinates in the two-dimensional key point coordinate set and the three-dimensional key point coordinates in the three-dimensional key point coordinate set according to the uncertainty factors, to obtain intermediate three-dimensional key point coordinates and intermediate two-dimensional key point coordinates, and then solve, according to the intermediate three-dimensional key point coordinates and the intermediate two-dimensional key point coordinates by using the PnP algorithm, the head pose corresponding to the target face image. In an example, the terminal device sorts the corresponding uncertainty factors of two-dimensional key point coordinates, eliminates 20% two-dimensional key point coordinates with the largest uncertainty factors, uses the retained intermediate two-dimensional key point coordinates to determine the corresponding intermediate three-dimensional key point coordinates for retaining, and then solves the head pose through PnP solution according to the retained intermediate two-dimensional key point coordinates and intermediate three-dimensional key point coordinates. In an example, the terminal device may use a built-in solve PnP algorithm of opencv. The principle of this method is to iteratively solve the pose, so that the intermediate 3D key point coordinates are as close as possible to the intermediate 2D key point coordinates after being projected by this pose.

In this way, the two-dimensional key point coordinate with a high uncertainty factor is eliminated, and head pose estimation is performed only based on the two-dimensional key point coordinate with a low uncertainty factor and a corresponding three-dimensional key point coordinate. This can effectively avoid that a key point with a high uncertainty factor affects the final pose estimation result, that is, avoid the negative effects caused by the key point with a high uncertainty factor, thereby making head pose solution more reliable and robust.

The technical solutions provided by the embodiments of this disclosure may be applied for virtual character construction, assisting gaze estimation, modeling attention, making 3D models suitable for videos, and performing facial alignment. In an exemplary application scenario, game character construction is taken as an example. A game device collects facial data of a user through a camera, performs head pose estimation to generate an image of a virtual object corresponding to the user, and then interacts with other virtual objects in the game through the virtual object to achieve game interaction.

A process in which the game device collects facial data through the camera and generates a virtual object based on the facial data may be shown in FIG. 7b. As shown in FIG. 7b, a head motion of the game character is generated by collecting a facial motion. Specifically, the collected to-be-processed image may be shown in (a) in FIG. 7b, that is, the head motion displayed in the target face image is head tilt. Then, the head pose estimation provided by the embodiments of the disclosure is shown in (b) in FIG. 7b, that is, the head motion of the corresponding game character is displayed synchronously as head tilt. In FIG. 7b, the corresponding head motion of the virtual object is generated by collecting the facial motion of the user, to improve the game interaction experience. At the same time, the head motion of the virtual object is synchronized in real time, which improves the data processing efficiency.

For example, the head pose estimation method may also be applied to live broadcasting or video recording. That is, when a user does not want to appear in the live video with his or her own appearance, facial data of the user may be collected through the camera, then the corresponding virtual character is generated based on the facial data, and then the virtual image is used for live broadcasting or video recording. In this way, the action of the virtual character may be synchronized with the action of the user, effectively implementing the interaction between the user and users watching the video and protecting user privacy.

A data set of 40 persons and about 500,000 images is obtained to evaluate the technical indicators of the method provided in the embodiments of this disclosure and other methods. There are three evaluation methods: 1. 6D0F parameters are directly estimated. 2. A PnP method is used, but without estimating uncertainty. 3. Results are shown in Table 1:

TABLE 1

| Method | pitch | yaw | roll | tx | ty | tz |
|---|---|---|---|---|---|---|
| 6D0F parameters are | 2.85 | 1.78 | 1.12 | 2.75 | 5.42 | 18.52 |
| directly estimated | | | | | | |
| PnP without | 2.12 | 1.23 | 0.85 | 2.03 | 3.48 | 13.45 |
| uncertainty | | | | | | |
| Technical solutions | 1.54 | 1.02 | 0.45 | 1.01 | 2.15 | 9.24 |
| provided by this | | | | | | |
| application | | | | | | |

As shown in table 1, comparisons are made in all 6 dimensions of 6DoF, which are pitch, yaw, roll, tx, ty, and tz. Based on the results, the technical solution provided by this application is significantly better than other methods in indicators of all dimensions.

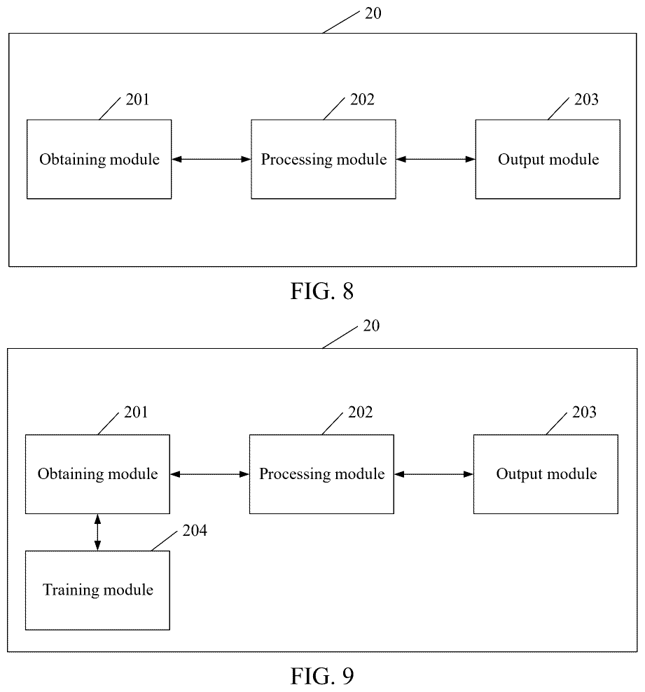

The following is a detailed description of the head pose estimation apparatus in this application. FIG. 8 is a schematic diagram of an embodiment of the head pose estimation apparatus according to an embodiment of this disclosure. A head pose estimation apparatus 20 includes:
an obtaining module 201, configured to obtain a to-be-recognized image, the to-be-recognized image including a target face image;
a processing module 202, configured to perform key point recognition processing through a first network model based on the to-be-recognized image, to obtain a two-dimensional key point coordinate set of the target face image in the to-be-recognized image and a three-dimensional key point coordinate set of the target face image, the first network model including a first branch network and a second branch network, the first branch network being configured for recognizing the two-dimensional key point coordinate set, and the second branch network being configured for recognizing the three-dimensional key point coordinate set; and
an output module 203, configured to determine, according to the two-dimensional key point coordinate set and the three-dimensional key point coordinate set, a head pose corresponding to the target face image in the to-be-recognized image.

An embodiment of this disclosure provides a head pose estimation apparatus. In the apparatus, the two branch networks are used to respectively output the 2D key point coordinates and the 3D key point coordinates of the target face image in the to-be-recognized image, and then calculate the head pose of the target face image based on the 2D key point coordinates and the 3D key point coordinates. Since the 3D key point coordinate may be obtained in real time, a 3D head model may change with changes in expressions. Correspondingly, the correspondence between the 2D key point coordinate and the 3D key point coordinate is more accurate, so that when a person makes a large expression, it is ensured that head pose estimation is stable and reliable.

In an embodiment, based on the embodiment corresponding to FIG. 8, in another embodiment of the head pose estimation apparatus 20 provided by this embodiment of this disclosure:

The processing module 202 is specifically configured to perform key point recognition processing through the first network model based on the to-be-recognized image, to obtain the two-dimensional key point coordinate set, an uncertainty factor corresponding to each two-dimensional key point coordinate in the two-dimensional key point coordinate set, and the three-dimensional key point coordinate set; where the first branch network in the first network model is further configured for recognizing the uncertainty factor corresponding to each two-dimensional key point coordinate in the two-dimensional key point coordinate set; and
the output module 203 is specifically configured to determine, according to the two-dimensional key point coordinate set, the uncertainty factor, and the three-dimensional key point coordinate set, the head pose corresponding to the target face image in the to-be-recognized image.

In an embodiment, based on the embodiment corresponding to FIG. 8, in another embodiment of the head pose estimation apparatus 20 provided by this embodiment of this disclosure:

The output module 203 is specifically configured to eliminate, from the two-dimensional key point coordinate set, a two-dimensional key point coordinate whose corresponding uncertainty factor is greater than a preset threshold, to obtain an intermediate two-dimensional key point coordinate set;
obtain an intermediate three-dimensional key point coordinate set from the three-dimensional key point coordinate set according to the intermediate two-dimensional key point coordinate set; and
determine, according to the intermediate two-dimensional key point coordinate set and the intermediate three-dimensional key point coordinate set, the head pose corresponding to the target face image in the to-be-recognized image.

An embodiment of this disclosure provides a head pose estimation apparatus. The apparatus filters the 2D key point coordinates and the 3D key point coordinates according to uncertainty factors corresponding to the 2D key point coordinates, so that points with large uncertainties are deleted when estimating the head pose, making the head pose estimation more robust.

In an embodiment, based on the embodiment corresponding to FIG. 8, in another embodiment of the head pose estimation apparatus 20 provided by this embodiment of this disclosure, the output module 203 is specifically configured to determine, through PnP solution according to the intermediate two-dimensional key point coordinate set and the intermediate three-dimensional key point coordinate set, the head pose corresponding to the target face image in the to-be-recognized image.

An embodiment of this disclosure provides a head pose estimation apparatus. The apparatus performs pose estimation through PnP solution, making head pose estimation more feasible.

In an embodiment, based on the embodiment corresponding to FIG. 8, in another embodiment of the head pose estimation apparatus 20 provided by this embodiment of this disclosure, as shown in FIG. 9:

The obtaining module 201 is further configured to obtain a first training sample set, where the first training sample set includes training samples that are labeled with face images and that are of a real two-dimensional key point coordinate set and a real three-dimensional key point coordinate set.

The head pose estimation apparatus further includes a training module 204, configured to perform, through a feature extraction network layer in a to-be-trained first initial network model, feature extraction processing on a face image corresponding to a training sample in the first training sample set, to obtain a feature representation of the training sample;
determine, through an initial first branch network in the first initial network model according to the feature representation of the training sample, a predicted two-dimensional key point coordinate set corresponding to the training sample; and determine, through an initial second branch network in the first initial network model according to the feature representation of the training sample, a predicted three-dimensional key point coordinate set corresponding to the training sample;
calculate a first loss value according to the predicted two-dimensional key point coordinate set and the real two-dimensional key point coordinate set in the training samples, and calculate a second loss value according to the predicted three-dimensional key point coordinate set and the real three-dimensional key point coordinate set in the training samples;
adjust the initial first branch network according to the first loss value to obtain the first branch network, and adjust the initial second branch network according to the second loss value to obtain the second branch network; and
obtain the first network model according to the first branch network and the second branch network.

An embodiment of this disclosure provides a head pose estimation apparatus. The apparatus obtains the first branch network and the second branch network through training in the training process, respectively outputs the 2D key point coordinates and the 3D key point coordinates of the target face image in the to-be-recognized image through the two branch networks, and then calculates the head pose of the target face image based on the 2D key point coordinates and the 3D key point coordinates. Since the 3D key point coordinate may be obtained in real time, a 3D head model may change with changes in expressions. Correspondingly, the correspondence between the 2D key point coordinate and the 3D key point coordinate is more accurate, so that when a person makes a large expression, it is ensured that head pose estimation is stable and reliable. At the same time, the first branch network and the second branch network are trained independently, which can increase the generalization performance of the model.

In an embodiment, based on the embodiment corresponding to FIG. 9, in another embodiment of the head pose estimation apparatus 20 provided by this embodiment of this disclosure, the training module 204 is specifically configured to:
determine, through the initial first branch network according to the feature representation of the training sample, a predicted two-dimensional key point coordinate set corresponding to the training samples and a predicted uncertainty factor corresponding to each predicted key point coordinate in the predicted two-dimensional key point coordinate set; and
calculate the first loss value according to the predicted two-dimensional key point coordinate set, the predicted uncertainty factor, and the real two-dimensional key point coordinate set.

In an embodiment, based on the embodiment corresponding to FIG. 9, in another embodiment of the head pose estimation apparatus 20 provided by this embodiment of this disclosure, the obtaining module 201 is specifically configured to collect a training image set through a depth camera, where each training image in the training image set includes three-dimensional point cloud data and a real head pose of a face image;
perform pose projection on the three-dimensional point cloud data to obtain two-dimensional key point data of the face image in the training image; and
determine the first training sample set through an image processing network according to the training image set.

An embodiment of this disclosure provides a head pose estimation apparatus. The apparatus collects training images through a depth camera, so that it is more convenient to obtain the 3D point cloud data and the real head pose, thereby simplifying the process of obtaining the training sample set.

In an embodiment, based on the embodiment corresponding to FIG. 9, in another embodiment of the head pose estimation apparatus 20 provided by this embodiment of this disclosure, the obtaining module 201 is specifically configured to determine sparse key points of the face image in the training image through the image processing network according to the training image in the training image set, where the sparse key points include facial feature points and face contour points of the face image in the training image;
obtain the face image from the training image according to the face contour points; and
horizontally align the face image and scale the face image to a target size according to the facial feature points, to obtain training samples in the first training sample set.

An embodiment of this disclosure provides a head pose estimation apparatus. The apparatus performs matting and alignment on the face image through sparse key points, which can reduce the interference caused by background information in the image collected by the camera. Besides, the image is scaled to a uniform size, to facilitate image feature extraction and reduce training difficulty.

In an embodiment, based on the embodiment corresponding to FIG. 9, in another embodiment of the head pose estimation apparatus 20 provided by this embodiment of this disclosure, the sparse key points include at least five facial feature points and four face contour points.

An embodiment of this disclosure provides a head pose estimation apparatus. The apparatus can reduce the image preprocessing process while ensuring accurate matting and alignment.

In an embodiment, based on the embodiment corresponding to FIG. 9, in another embodiment of the head pose estimation apparatus 20 provided by this embodiment of this disclosure, the feature extraction network includes a residual neural network ResNet and a pooling layer, the first branch network is a fully connected layer, and the second branch network is a fully connected layer.

An embodiment of this disclosure provides a head pose estimation apparatus. The apparatus can increase the feasibility of the solution.

In an embodiment, based on the embodiment corresponding to FIG. 9, in another embodiment of the head pose estimation apparatus 20 provided by this embodiment of this disclosure, the training module 204 is specifically configured to calculate the first loss value according to the predicted two-dimensional key point coordinate set, the predicted uncertainty factor, and the real two-dimensional key point coordinate set by using Gaussian negative log likelihood loss; and calculate the second loss value according to the predicted three-dimensional key point coordinate set and the real three-dimensional key point coordinate set by using a regression loss function.

An embodiment of this disclosure provides a head pose estimation apparatus. The apparatus can increase the feasibility of the solution.

In an embodiment, based on the embodiment corresponding to FIG. 8, in another embodiment of the head pose estimation apparatus 20 provided by this embodiment of this disclosure, as shown in FIG. 9:

The obtaining module 201 is specifically configured to obtain a second training sample set, where the second training sample set includes training samples that are labeled with face images and that are of a real two-dimensional key point coordinate set, a real three-dimensional key point coordinate set, and a real head pose.

The head pose estimation apparatus further includes a training module 204, configured to perform, through a feature extraction network layer in a to-be-trained second initial network model, feature extraction processing on a face image corresponding to a training sample in the second training sample set, to obtain a feature representation of the training sample;
determine, through an initial first branch network in the second initial network model according to the feature representation of the training sample, a predicted two-dimensional key point coordinate set corresponding to the training sample; determine, through an initial second branch network in the second initial network model according to the feature representation of the training sample, a predicted three-dimensional key point coordinate set corresponding to the training sample;
calculate a predicted head pose through a computing network in the second initial network model according to the predicted two-dimensional key point coordinate set and the predicted three-dimensional key point coordinate set;
calculate a first loss value according to the predicted two-dimensional key point coordinate set and the real two-dimensional key point coordinate set in the training samples, calculate a second loss value according to the predicted three-dimensional key point coordinate set and the real three-dimensional key point coordinate set in the training samples; and calculate a third loss value according to the predicted head pose and a real head pose in the training sample; and
adjust the second initial network model according to the first loss value, the second loss value, and the third loss value, to obtain the first network model.

An embodiment of this disclosure provides a head pose estimation apparatus. The apparatus obtains the first branch network and the second branch network through training in the training process, respectively outputs the 2D key point coordinates and the 3D key point coordinates of the target face image in the to-be-recognized image through the two branch networks, and then calculates the head pose of the target face image based on the 2D key point coordinates and the 3D key point coordinates. Since the 3D key point coordinate may be obtained in real time, a 3D head model may change with changes in expressions. Correspondingly, the correspondence between the 2D key point coordinate and the 3D key point coordinate is more accurate, so that when a person makes a large expression, it is ensured that head pose solution is stable and reliable. At the same time, the first branch network and the second branch network are jointly trained, thereby increasing the learning performance of the model.

In an embodiment, based on the embodiment corresponding to FIG. 9, in another embodiment of the head pose estimation apparatus 20 provided by this embodiment of this disclosure, the training module 204 is specifically configured to:
determine, through the initial first branch network according to the feature representation of the training sample, a predicted two-dimensional key point coordinate set corresponding to the training samples and a predicted uncertainty factor corresponding to each predicted key point coordinate in the predicted two-dimensional key point coordinate set; and
calculate the first loss value according to the predicted two-dimensional key point coordinate set, the predicted uncertainty factor, and the real two-dimensional key point coordinate set.

In an embodiment, based on the embodiment corresponding to FIG. 9, in another embodiment of the head pose estimation apparatus 20 provided by this embodiment of this disclosure, the feature extraction network includes a residual neural network ResNet and a pooling layer, the first branch network is a fully connected layer, and the second branch network is a fully connected layer. The computing network is a differentiable PnP solution network.

An embodiment of this disclosure provides a head pose estimation apparatus. The apparatus can increase the feasibility of the solution.

In an embodiment, based on the embodiment corresponding to FIG. 8, in another embodiment of the head pose estimation apparatus 20 provided by this embodiment of this disclosure, the obtaining module 201 is specifically configured to obtain a to-be-processed image, where the to-be-processed image includes a target face image captured by a camera;
determine sparse key points of the target face image in the to-be-processed image through an image preprocessing network, where the sparse key points include facial feature points and face contour points of the target face image;
obtain the target face image from the to-be-processed image according to the face contour points; and
horizontally align the target face image and scale the target face image to a target size according to the facial feature points to obtain the to-be-recognized image.

An embodiment of this disclosure provides a head pose estimation apparatus. The apparatus performs matting and alignment on the face image through sparse key points, which can reduce the interference caused by background information in the image collected by the camera. The image is scaled to a uniform size, to facilitate feature extraction of the image.

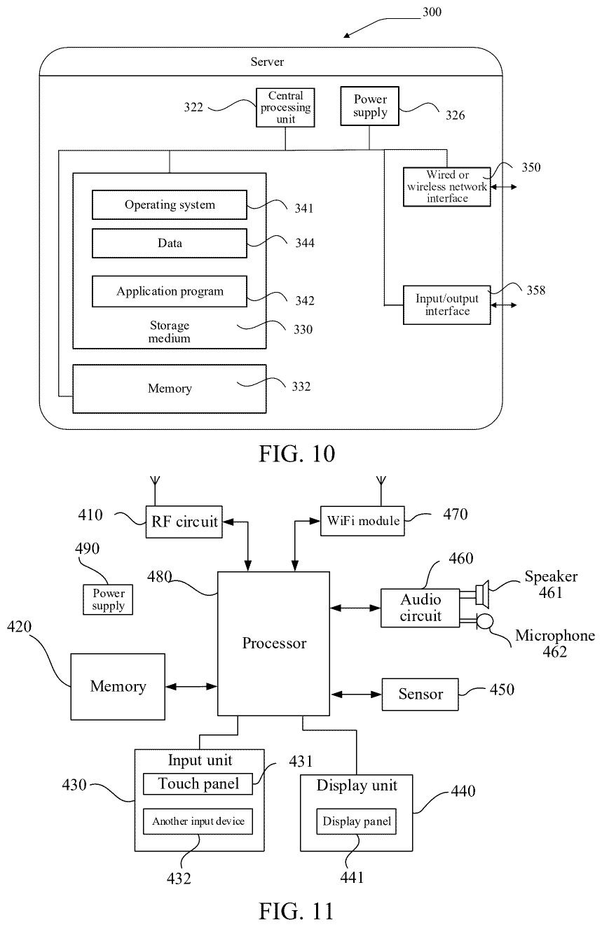

The head pose estimation apparatus provided in this application may be applied to a server. FIG. 10 is a schematic structural diagram of a server according to an embodiment of this disclosure. The server 300 may greatly differ as configuration or performance differs, may include one or more central processing units (CPU) 322 (for example, one or more processors, processing circuitry), a memory 332, such as a non-transitory computer-readable storage medium, and one or more storage mediums 330 storing an application program 342 or data 344 (for example, one or more mass storage devices). The memory 332 and the storage medium 330 may be used for transient storage or permanent storage. A program stored in the storage medium 330 may include one or more modules (which are not marked in the figure), and each module may include a series of instruction operations on the server. Further, the central processing unit 322 may be set to communicate with the storage medium 330, and execute, on the server 300, a series of instructions and operations in the storage medium 330.

The server 300 may further include one or more power supplies 326, one or more wired or wireless network interfaces 350, one or more input/output interfaces 358, and/or one or more operating systems 341 such as Windows Server™, Mac OS X™, Unix™, Linux™, and FreeBSD™.

The operations performed by the server in the foregoing embodiment may be based on the server structure shown in FIG. 10.

The head pose estimation apparatus provided in this application may be applied to a terminal device. Referring to FIG. 11, for ease of description, only the parts related to the embodiments of this disclosure are shown. For specific technical details not disclosed, refer to the method of the embodiments of this disclosure. In an example in which the terminal device is a smartphone is used for description.

FIG. 11 is a block diagram of a structure of a part of a smartphone related to a terminal device according to an embodiment of this disclosure. Referring to FIG. 11, the smartphone includes: components such as: a radio frequency (RF) circuit 410, a memory 420, an input unit 430, a display unit 440, a sensor 450, an audio circuit 460, Wi-Fi module 470, a processor 480, and a power supply 490. A person skilled in the art may understand that the structure of the smartphone shown in FIG. 11 does not constitute a limitation on the smartphone, and the smartphone may include more components or fewer components than those shown in the figure, or some components may be combined, or a different component deployment may be used.

The following makes a specific description of components of the smartphone with reference to FIG. 11.

The RF circuit 410 may be configured to receive and send signals during an information receiving and sending process or a call process. Specifically, the RF circuit 410 receives downlink information from a base station, then delivers the downlink information to the processor 480, such as processing circuitry, for processing, and sends related uplink data to the base station. Usually, the RF circuit 410 includes, but is not limited to, an antenna, at least one amplifier, a transceiver, a coupler, a low noise amplifier (LNA), and a duplexer. In addition, the RF circuit 410 may also communicate with a network and another device by means of wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 420, such as a non-transitory computer-readable storage medium, may be configured to store a software program and module. The processor 480 runs the software program and module stored in the memory 420, to implement various functional applications and data processing of the smartphone. The memory 420 may mainly include a program storage area and a data storage area. The program storage area may store an operating system, an application program required by at least one function (for example, a sound playing function and an image playing function), or the like. The data storage area may store data (for example, audio data and a phone book) created according to use of the smartphone. In addition, the memory 420 may include a high speed random access memory, and may also include a non-volatile memory, such as at least one magnetic disk storage device, a flash memory, or another volatile solid-state storage device.

The input unit 430 may be configured to receive input digit or character information, and generate a keyboard signal input related to the user setting and function control of the smartphone. Specifically, the input unit 430 may include a touch panel 431 and another input device 432. The touch panel 431, which may also be referred to as a touch screen, may collect a touch operation of a user on or near the touch panel (such as an operation of a user on or near the touch panel 431 by using any suitable object or accessory such as a finger or a stylus), and drive a corresponding connection apparatus according to a preset program. In an embodiment, the touch panel 431 may include two parts: a touch detection apparatus and a touch controller. The touch detection apparatus detects a touch location of the user, detects a signal carried by a touch operation, and transmits the signal to the touch controller. The touch controller receives touch information from the touch detection apparatus, converts the touch information to touch point coordinates, sends the touch point coordinates to the processor 480, and receives and executes a command from the processor 480. In addition, the touch panel 431 may be implemented by using various types, such as a resistive type, a capacitance type, an infrared type, and a surface sound wave type. In addition to the touch panel 431, the input unit 430 may further include the another input device 432. Specifically, the another input device 432 may include, but is not limited to, one or more of a physical keyboard, a functional key (such as a volume control key or a switch key), a track ball, a mouse, and a joystick.

The display unit 440 may be configured to display information input by the user or information provided for the user, and various menus of the smartphone. The display unit 440 may include a display panel 441. In an embodiment, the display panel 441 may be configured by using a liquid crystal display (LCD), an organic light-emitting diode (OLED), or the like. Further, the touch panel 431 may cover the display panel 441. After detecting a touch operation on or near the touch panel, the touch panel 431 transfers the touch operation to the processor 480, to determine a type of a touch event. Then, the processor 480 provides a corresponding visual output on the display panel 441 according to the type of the touch event. Although in FIG. 11, the touch panel 431 and the display panel 441 are used as two separate parts to implement input and output functions of the smartphone, in some embodiments, the touch panel 431 and the display panel 441 may be integrated to implement the input and output functions of the smartphone.

The smartphone may further include at least one sensor 450 such as an optical sensor, a motion sensor, and other sensors. Specifically, the optical sensor may include an ambient light sensor and a proximity sensor, where the ambient light sensor may adjust luminance of the display panel 441 according to the luminance of the ambient light, and the proximity sensor may switch off the display panel 441 and/or backlight when the smartphone is moved to the ear. As one type of motion sensor, an acceleration sensor may detect magnitude of accelerations in various directions (generally on three axes), may detect magnitude and a direction of the gravity when static, and may be applied to an application that recognizes the pose of the smartphone (for example, switching between landscape orientation and portrait orientation, a related game, and magnetometer pose calibration), a function related to vibration recognition (such as a pedometer and a knock), and the like. Other sensors, such as a gyroscope, a barometer, a hygrometer, a thermometer, and an infrared sensor, which may be configured in the smartphone, are not further described herein.

The audio circuit 460, a speaker 461, and a microphone 462 may provide audio interfaces between the user and the smartphone. The audio circuit 460 may convert received audio data into an electric signal and transmit the electric signal to the loudspeaker 461. The loudspeaker 461 converts the electric signal into a sound signal and output the sound signal. In another aspect, the microphone 462 converts a collected sound signal into an electric signal. The audio circuit 460 receives the electric signal, converts the electric signal into audio data, and outputs the audio data to the processor 480 for processing. Then, the processor sends the audio data to another smartphone by using the RF circuit 410, or outputs the audio data to the memory 420 for further processing.

Wi-Fi belongs to a short distance wireless transmission technology. The smartphone may help, by using the Wi-Fi module 470, a user to receive and send an email, browse a web page, access stream media, and the like. This provides wireless broadband Internet access for the user. Although FIG. 11 shows the Wi-Fi module 470, the Wi-Fi module is not a necessary component of the smartphone, and may be omitted as required provided that the scope of the essence of the present disclosure is not changed.

The processor 480 is a control center of the smartphone, and is connected to various parts of the entire smartphone by using various interfaces and lines. By running or executing a software program and/or module stored in the memory 420, and invoking data stored in the memory 420, the processor executes various functions of the smartphone and performs data processing, thereby monitoring the entire smartphone. In an embodiment, the processor 480 may include one or more processing units. In an embodiment, the processor 480 may integrate an application processor and a modem. The application processor mainly processes an operating system, a user interface, an application program, and the like. The modem mainly processes wireless communication. The foregoing modem may either not be integrated into the processor 480.

The smartphone further includes the power supply 490 (such as a battery) for supplying power to the components. In an embodiment, the power supply may be logically connected to the processor 480 by using a power management system, thereby implementing functions such as charging, discharging and power consumption management by using the power management system.

Although not shown in the figure, the smartphone may further include a camera, a Bluetooth module, and the like, which are not further described herein.

Operations performed by the terminal device in the foregoing embodiment may be based on a structure of the terminal device that is shown in FIG. 11.

An embodiment of this disclosure further provides a computer-readable storage medium. The computer-readable storage medium stores a computer program. When the computer program runs on a computer, the computer is caused to perform the methods according to the foregoing embodiments.

An embodiment of this disclosure further provides a computer program product including a program, and when the program runs on a computer, the computer is caused to perform the methods according to the foregoing embodiments.

A person skilled in the art can clearly understand that for convenience and conciseness of description, for specific working processes of the foregoing systems, devices and units, refer to the corresponding processes in the foregoing method embodiments, and details are not described herein again.

In the several embodiments provided in this disclosure, the disclosed system, apparatus, and method may be implemented in other manners. For example, the described apparatus embodiment is merely an example. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of this disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. The technical solutions may be implemented in the form of a software product. The computer software product is stored in a storage medium and includes several instructions for instructing a computer device (which may be a personal computer, a server, a network device, or the like) to perform all or some of the operations of the methods described in the embodiments of this disclosure. The foregoing storage medium includes any medium that may store program code, such as a USB flash drive, a removable hard disk, a read-only memory (ROM), a random access memory (RAM), a magnetic disk, or an optical disc.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing embodiments are merely used for describing example solutions of this disclosure, but are not intended to limit this disclosure. Although this disclosure is described in detail with reference to the foregoing embodiments, it should be appreciated by a person skilled in the art that, modifications may still be made to the technical solutions described in the foregoing embodiments, or equivalent replacements may be made to the part of the technical features; as long as such modifications or replacements do not cause the essence of corresponding technical solutions to depart from the spirit and scope of the technical solutions of the embodiments of this disclosure.

What is claimed is:

1. A pose estimation method, comprising:
obtaining an image by processing circuitry, the image including a target face;
performing key point recognition processing through a first network model based on the image, to obtain a two-dimensional key point coordinate set and a three-dimensional key point coordinate set of the target face, the first network model including a first branch network that is configured to recognize the two-dimensional key point coordinate set and a second branch network that is configured to recognize the three-dimensional key point coordinate set; and
determining, according to the two-dimensional key point coordinate set and the three-dimensional key point coordinate set, a head pose corresponding to the target face in the image.

2. The method according to claim 1, wherein the method further comprises:
determining an uncertainty factor corresponding to the two-dimensional key point coordinate set and the three-dimensional key point coordinate set, wherein the first branch network of the first network model is further configured to recognize the uncertainty factor corresponding to each two-dimensional key point coordinate in the two-dimensional key point coordinate set; and
wherein the head pose corresponding to the target face in the image is determined based on the uncertainty factor corresponding to the two-dimensional key point coordinate set and the three-dimensional key point coordinate set.

3. The method according to claim 2, wherein the method further comprises:
obtaining an intermediate two-dimensional key point coordinate set, wherein the uncertainty factor of the intermediate two-dimensional key point coordinate set is less than a preset threshold;
obtaining an intermediate three-dimensional key point coordinate set based on the intermediate two-dimensional key point coordinate set; and
determining, according to the intermediate two-dimensional key point coordinate set and the intermediate three-dimensional key point coordinate set, the head pose corresponding to the target face in the image.

4. The method according to claim 3, wherein the method further comprises:
determining, through perspective-n-point (PnP) solution according to the intermediate two-dimensional key point coordinate set and the intermediate three-dimensional key point coordinate set, the head pose corresponding to the target face in the image.

5. The method according to claim 1, wherein the method further comprises:
obtaining a first training sample set;
performing, based on a feature extraction network layer in a first initial network model, a feature extraction processing on a face image corresponding to a training sample of the first training sample set, to obtain a feature representation of the training sample;
determining, based on an initial first branch network in the first initial network model according to the feature representation of the training sample, a predicted two-dimensional key point coordinate set;
determining, based on an initial second branch network in the first initial network model according to the feature representation of the training sample, a predicted three-dimensional key point coordinate set;
calculating a first loss value according to the predicted two-dimensional key point coordinate set and a real two-dimensional key point coordinate set in the training samples, and calculating a second loss value according to the predicted three-dimensional key point coordinate set and a real three-dimensional key point coordinate set in the training samples;
adjusting the initial first branch network according to the first loss value to obtain the first branch network, and adjusting the initial second branch network according to the second loss value to obtain the second branch network; and
obtaining the first network model according to the first branch network and the second branch network.

6. The method according to claim 5, wherein the method further comprises:
collecting a training image set through a depth camera, wherein each training image in the training image set includes three-dimensional point cloud data and a real head pose;
performing head pose projection on the three-dimensional point cloud data to obtain two-dimensional key point data of the training image; and
determining the first training sample set based on an image processing network according to the training image set.

7. The method according to claim 5, wherein the feature extraction network comprises a residual neural network (ResNet) and a pooling layer, the first branch network is a fully connected network, and the second branch network is a fully connected network.

8. The method according to claim 1, wherein the method further comprises:
obtaining a to-be-processed image;
determining sparse key points of a target face in the to-be-processed image based on an image preprocessing network, wherein the sparse key points includes facial feature points and face contour points of the target face in the to-be-processed image; and
obtaining the target face image from the to-be-processed image according to the face contour points.

9. An apparatus, the apparatus comprising:
processing circuitry configured to:
obtain an image that includes a target face;
perform key point recognition processing through a first network model based on the image, to obtain a two-dimensional key point coordinate set and a three-dimensional key point coordinate set of the target face, the first network model including a first branch network that is configured to recognize the two-dimensional key point coordinate set and a second branch network that is configured to recognize the three-dimensional key point coordinate set; and
determine, according to the two-dimensional key point coordinate set and the three-dimensional key point coordinate set, a head pose corresponding to the target face in the image.

10. The apparatus according to claim 9, wherein the processing circuitry is configured to:
determine an uncertainty factor corresponding to the two-dimensional key point coordinate set and the three-dimensional key point coordinate set, wherein the first branch network of the first network model is further configured to recognize the uncertainty factor corresponding to each two-dimensional key point coordinate in the two-dimensional key point coordinate set; and
wherein the head pose corresponding to the target face in the image is determined based on the uncertainty factor corresponding to the two-dimensional key point coordinate set and the three-dimensional key point coordinate set.

11. The apparatus according to claim 10, wherein the processing circuitry is configured to:
obtain an intermediate two-dimensional key point coordinate set, wherein the uncertainty factor of the intermediate two-dimensional key point coordinate set is less than a preset threshold;
obtain an intermediate three-dimensional key point coordinate set based on the intermediate two-dimensional key point coordinate set; and
determine, according to the intermediate two-dimensional key point coordinate set and the intermediate three-dimensional key point coordinate set, the head pose corresponding to the target face in the image.

12. The apparatus according to claim 11, wherein the processing circuitry is configured to:
determine, through perspective-n-point (PnP) solution according to the intermediate two-dimensional key point coordinate set and the intermediate three-dimensional key point coordinate set, the head pose corresponding to the target face in the image.

13. The apparatus according to claim 9, wherein the processing circuitry is configured to:
obtain a first training sample set;
perform, based on a feature extraction network layer in a first initial network model, a feature extraction processing on a face image corresponding to a training sample of the first training sample set, to obtain a feature representation of the training sample;
determine, based on an initial first branch network in the first initial network model according to the feature representation of the training sample, a predicted two-dimensional key point coordinate set;
determine, based on an initial second branch network in the first initial network model according to the feature representation of the training sample, a predicted three-dimensional key point coordinate set;
calculate a first loss value according to the predicted two-dimensional key point coordinate set and a real two-dimensional key point coordinate set in the training samples, and calculate a second loss value according to the predicted three-dimensional key point coordinate set and a real three-dimensional key point coordinate set in the training samples;
adjust the initial first branch network according to the first loss value to obtain the first branch network, and adjust the initial second branch network according to the second loss value to obtain the second branch network; and
obtain the first network model according to the first branch network and the second branch network.

14. The apparatus according to claim 13, wherein the processing circuitry is configured to:
collect a training image set through a depth camera, wherein each training image in the training image set includes three-dimensional point cloud data and a real head pose;
perform head pose projection on the three-dimensional point cloud data to obtain two-dimensional key point data of the training image; and
determine the first training sample set based on an image processing network according to the training image set.

15. A non-transitory computer-readable storage medium, storing instructions which when executed by a processor cause the processor to perform:
obtaining an image that includes a target face;
performing key point recognition processing through a first network model based on the image, to obtain a two-dimensional key point coordinate set and a three-dimensional key point coordinate set of the target face, the first network model including a first branch network that is configured to recognize the two-dimensional key point coordinate set and a second branch network that is configured to recognize the three-dimensional key point coordinate set; and
determining, according to the two-dimensional key point coordinate set and the three-dimensional key point coordinate set, a head pose corresponding to the target face in the image.

16. The non-transitory computer-readable storage medium according to claim 15, wherein the instructions when executed by the processor further cause the processor to perform:
determining an uncertainty factor corresponding to the two-dimensional key point coordinate set and the three-dimensional key point coordinate set, wherein the first branch network of the first network model is further configured to recognize the uncertainty factor corresponding to each two-dimensional key point coordinate in the two-dimensional key point coordinate set; and
wherein the head pose corresponding to the target face in the image is determined based on the uncertainty factor corresponding to the two-dimensional key point coordinate set and the three-dimensional key point coordinate set.

17. The non-transitory computer-readable storage medium according to claim 16, wherein the instructions when executed by the processor further cause the processor to perform:
obtaining an intermediate two-dimensional key point coordinate set, wherein the uncertainty factor of the intermediate two-dimensional key point coordinate set is less than a preset threshold;
obtaining an intermediate three-dimensional key point coordinate set based on the intermediate two-dimensional key point coordinate set; and
determining, according to the intermediate two-dimensional key point coordinate set and the intermediate three-dimensional key point coordinate set, the head pose corresponding to the target face in the image.

18. The non-transitory computer-readable storage medium according to claim 17, wherein the instructions when executed by the processor further cause the processor to perform:
determining, through perspective-n-point (PnP) solution according to the intermediate two-dimensional key point coordinate set and the intermediate three-dimensional key point coordinate set, the head pose corresponding to the target face in the image.

19. The non-transitory computer-readable storage medium according to claim 15, wherein the instructions when executed by the processor further cause the processor to perform:
obtaining a first training sample set;
performing, based on a feature extraction network layer in a first initial network model, a feature extraction processing on a face image corresponding to a training sample of the first training sample set, to obtain a feature representation of the training sample;
determining, based on an initial first branch network in the first initial network model according to the feature representation of the training sample, a predicted two-dimensional key point coordinate set;
determining, based on an initial second branch network in the first initial network model according to the feature representation of the training sample, a predicted three-dimensional key point coordinate set;
calculating a first loss value according to the predicted two-dimensional key point coordinate set and a real two-dimensional key point coordinate set in the training samples, and calculating a second loss value according to the predicted three-dimensional key point coordinate set and a real three-dimensional key point coordinate set in the training samples;
adjusting the initial first branch network according to the first loss value to obtain the first branch network, and adjusting the initial second branch network according to the second loss value to obtain the second branch network; and
obtaining the first network model according to the first branch network and the second branch network.

20. The non-transitory computer-readable storage medium according to claim 19, wherein the instructions when executed by the processor further cause the processor to perform:
collecting a training image set through a depth camera, wherein each training image in the training image set includes three-dimensional point cloud data and a real head pose;
performing head pose projection on the three-dimensional point cloud data to obtain two-dimensional key point data of the training image; and
determining the first training sample set based on an image processing network according to the training image set.
